(19) United States
(12) Patent Application Publication
(10) Pub. No.: US 2016/0224227 A1
(43) Pub. Date: Aug. 4, 2016

(54) Indication Display System

(71) Applicant: Caterpillar Inc., Peoria, IL (US)

(72) Inventors: Jeffrey Brush, Dunlap, IL (US); Steven McCoy, Washington, IL (US); Rodrigo Sanchez, Dunlap, IL (US)

(73) Assignee: Caterpillar Inc., Peoria, IL (US)

(21) Appl. No.: 14/608,542

(22) Filed: Jan. 29, 2015

(51) Int. Cl. G06F 3/0484; G06F 3/0488; B60K 37/02; G06F 3/0482

(52) U.S. Cl. CPC G06F 3/04847; G06F 3/0482; G06F 3/0488; G06F 3/04842; B60K 37/02

(57) ABSTRACT

An indication display system for a machine and a method displaying operational information of the machine are described. One method may include, in response to receiving an indication of a first machine condition, causing display of a first pop-up message in an information banner of a display screen of an operator interface, the first pop-up message including data describing the first machine condition, causing display of machine performance information in a machine performance information display section of the display screen simultaneously with displaying the first pop-up message, the information banner being disposed in non-overlapping relationship with the machine performance information display section of the display screen, and causing illumination of a first fixed indicator light disposed adjacent the machine performance information display section simultaneously with displaying the first pop-up message.

### TECHNICAL FIELD

This disclosure relates generally to an indication display system for a machine, and, more particularly, to an indication display system having an operator interface mounted in an operator cab of a machine.

### BACKGROUND

In a variety of engine-powered machines, monitoring devices are employed to detect the presence of various undesirable operating conditions, such as the overheating of the engine, low oil pressure, low fuel and the like. Indicators are provided to warn the operator of such conditions.

The degree of importance of the various monitored conditions may vary. For example, the air filter for the engine or the filter for the hydraulic fluid may gradually clog during operation of the vehicle. Generally, there is no need to remedy the situation until the end of the day when the machine returns for normal servicing and maintenance. A low fuel condition requires more immediate attention from the operator. A loss of engine oil pressure or a loss of hydraulic fluid represent conditions which require immediate operator attention to prevent damaging the machine.

Prior monitoring systems have detected the presence of undesirable conditions and then signaled the operator by means of dial indicators, indicator lamps, or audible means. The efficiency of these systems may depend upon the operator's careful attention to all of the various indicators and upon his judgment as to which may call for immediate correction. As the complexity of a machine increases, the number of monitored parameters generally increases. Therefore, the operator is required to direct more attention to the increasing number of indicators and less attention to operating the machine.

U.S. Pat. No. 4,442,424 is entitled, “Method and System for Displaying Vehicle Operating Parameters in a Variable Format.” The '424 patent is directed to a display system wherein a plurality of engine operating parameters and useful information items are monitored by respective sensors. A control unit receives signals from the sensors to display the monitored items in a variable format on a single viewing screen in accordance with the conditions of the monitored items. When an abnormal condition of one of the monitored items is detected by the control unit, the display format of the monitored item with an abnormal condition is enlarged to give a warning indication. A pushbutton is provided for each of the monitored items to generate a display command signal in response to a manual command to provide a display of a desired item in an enlarged format. However, as the number of discrete warning messages increases, so does demand for space on the display screen and attention by the operator. These and other shortcomings are addressed by the present disclosure.

### SUMMARY

In one aspect, the disclosure describes an indication display system for a machine, the system including an operator interface including a display screen, the display screen having at least one fixed indicator light and a machine performance information display section configured to display information indicating at least one machine parameter and a message display section configured to selectively display at least one pop-up message, wherein the fixed indicator light is disposed adjacent a portion of the machine performance information display section, a data storage device, the data storage device storing at least message data, and a controller operably arranged with the data storage device and the operator interface, the controller, in response to receiving a signal indicative of a first machine condition, configured to illuminate the fixed indicator light and to assemble from the message data in the data storage device a first pop-up message describing the first machine condition and to provide the first pop-up message to the operator interface for display in the message display section of the display screen simultaneously with illumination of the fixed indicator light.

In another aspect, the disclosure describes a machine configured to be controlled by an operator, the machine including a frame, a plurality of ground-engaging devices mounted to the frame, an engine operably coupled to at least one of the plurality of ground-engaging devices, an operator compartment supported by the frame, and an indication display system, the indication display system including: an operator interface including a display screen, the display screen having at least one fixed indicator light and a machine performance information display section configured to display information indicating at least one machine parameter and a message display section configured to selectively display at least one pop-up message, wherein the fixed indicator light is disposed adjacent a portion of the machine performance information display section, a data storage device, the data storage device storing at least message data, and a controller operably arranged with the data storage device and the operator interface, the controller, in response to receiving a signal indicative of a first machine condition, configured to illuminate the fixed indicator light and to assemble from the message data in the data storage device a first pop-up message describing the first machine condition and to provide the first pop-up message to the operator interface for display in the message display section of the display screen simultaneously with illumination of the fixed indicator light.

In yet another aspect, the disclosure describes methods of displaying information including, in response to receiving an indication of a first machine condition, causing display of a first pop-up message in an information banner of a display screen of an operator interface, the first pop-up message including data describing the first machine condition, causing display of machine performance information in a machine performance information display section of the display screen simultaneously with displaying the first pop-up message, the information banner being disposed in non-overlapping relationship with the machine performance information display section of the display screen, and causing illumination of a first fixed indicator light disposed adjacent the machine performance information display section simultaneously with displaying the first pop-up message.

Further and alternative aspects and features of the disclosed principles will be appreciated from the following detailed description and the accompanying drawings. As will be appreciated, the indication display systems for a machine, the machines, and the methods of displaying operational information of a machine disclosed herein are capable of being carried out in other and different aspects, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a side elevational view of an aspect of a machine suitable for use with an aspect of an indication display system for a machine constructed in accordance with aspects of the disclosure.

FIG. 2 is a schematic and diagrammatic view of an aspect of an indication display system for a machine constructed in accordance with aspects of the disclosure.

FIG. 3 is a front perspective view of an operator interface of the indication display system of FIG. 2.

FIG. 4 is a rear perspective view of the operator interface of FIG. 3.

FIG. 5 is a front elevational view of the operator interface of FIG. 3, illustrating a display screen in landscape orientation in accordance with aspects of the disclosure.

FIG. 6 is a front elevational view of the operator interface of FIG. 3, illustrating a display screen in portrait orientation in accordance with aspects of the disclosure.

FIG. 7 is a view of an aspect of a pop-up message suitable for display in a dedicated information banner of a display screen in accordance with aspects of the disclosure.

FIGS. 8, 9, and 10 are views of aspects of a pop-up message suitable for display in a dedicated information banner of a display screen, where the pop-up messages include three different levels of warnings in a priority hierarchy in accordance with aspects of the disclosure.

FIG. 11 is a flow chart illustrating steps of a method for alerting an operator of a machine in accordance with aspects of the disclosure.

FIG. 12 is a front elevational view of the operator interface of FIG. 5, illustrating a level 1 warning level.

FIG. 13 is a front elevational view of the operator interface of FIG. 5, illustrating a level 2 warning level.

FIG. 14 is a front elevational view of the operator interface of FIG. 5, illustrating a level 3 warning level.

### DETAILED DESCRIPTION

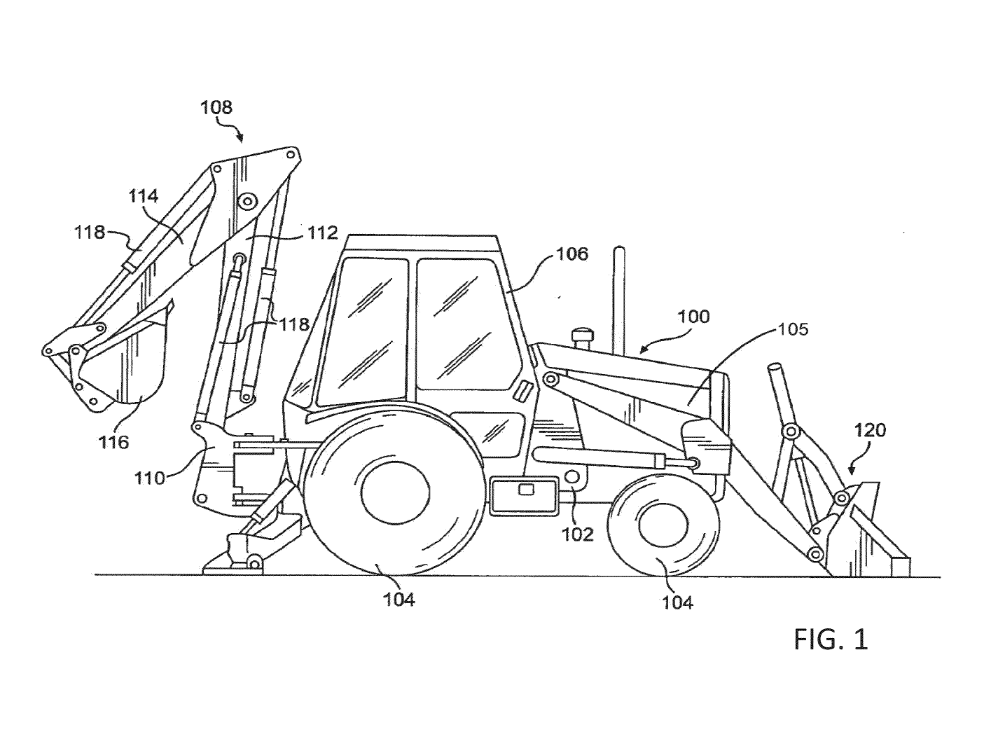

Referring now to the drawings, an exemplary aspect of a machine 100 is shown in FIG. 1 which is suitable for use with an aspect of an indication display system constructed in accordance with aspects of the disclosure. The machine 100 may be configured to be controlled by an operator. The machine 100 may include a frame 102, a plurality of ground-engaging devices 104 mounted to the frame 102, an engine 105 operably coupled to at least one of the ground-engaging devices 104, and an operator compartment 106 supported by the frame 102. The illustrated ground-engaging devices 104 are in the form of wheels. In other aspects, other suitable ground-engaging device may be used, such as, tracks or belts, for example.

In the aspect shown, the machine 100 includes a mechanical linkage 108 having a swing frame 110, a boom member 112, a stick member 114, a work implement 116, and actuators 118. The actuators 118 provide movement and control to the mechanical linkage 108 as is known in the art. The actuators 118 may be any suitable device for providing selective movement of the mechanical linkage 108, such as hydraulic-powered cylinders or other types of actuators suitable for moving the mechanical linkage 108.

The illustrated machine 100 is of a type commonly referred to as a backhoe loader and may further include a front work implement assembly 120, such as, for example, a loader bucket assembly. The loader bucket assembly may be connected to the frame 102 at a front portion of the machine 100.

In other aspects, the principles disclosed herein may be incorporated and used with other machines, such as fixed or mobile machines that are used in industries including mining, construction, forestry, farming, etc. Non-limiting examples of other mobile machines include commercial machines, such as trucks, cranes, earth moving vehicles, mining vehicles, cold planers, wheel loaders, backhoes, motor graders, track type tractors, hydraulic excavators, track type loaders, material handling equipment, farming equipment, marine vessels, aircraft, off-road vehicles, and other types of movable machines. Moreover, the principles disclosed herein may be incorporated in with other machines that are not movable including generator sets, turbines, mining equipment, and the like.

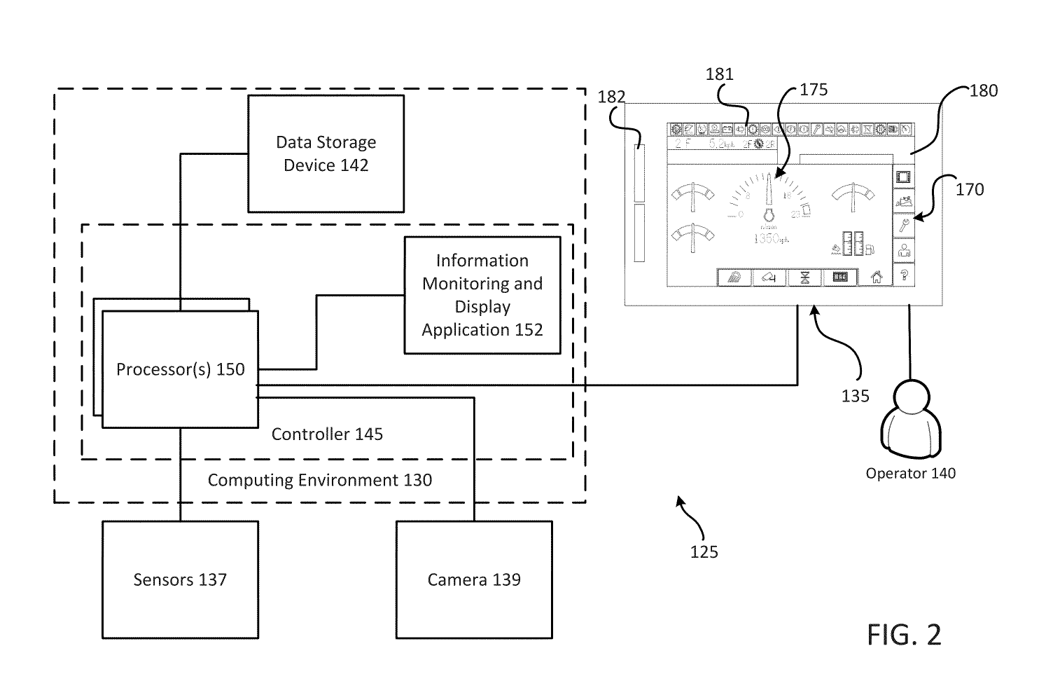

Referring to FIG. 2, an exemplary aspect of an indication display system 125 constructed in accordance with principles of the disclosure is shown. The indication display system 125 may include a computing environment 130 operably arranged with an operator interface 135, sensors 137, a camera 139, or any combination thereof. The operator interface 135 may be disposed within the operator compartment 106 of the machine. An operator 140 may use the operator interface 135 to receive information from the indication display system 125 and to provide inputs to various machine components through the operator interface 135. The operator interface 135 may be configured to provide information in the form of visibly-displayed indicia. In some aspects, an audio device may be associated with the operator interface 135 to provide audibly-perceptible information through a speaker.

The computing environment 130 may include a data storage device 142 storing data, such as message data, and a controller 145. The controller 145 may be operably arranged with the data storage device 142, the operator interface 135, the sensors 137, and the camera 139. The controller 145 may include a processor 150 and a non-transitory, tangible computer-readable storage medium bearing instructions including an information monitoring and display application 152. When executed by the processor 150, the information monitoring and display application 152 provides the controller 145 with the functionality to provide the display configurations described herein.

The data storage device 142 may include any type of system for storing data in a non-volatile storage. This includes, but is not limited to, systems based upon: magnetic, optical, and magneto-optical storage devices, as well as storage devices based on flash memory and/or battery-backed up memory. The data storage device 142 may include a removable memory module, or a fixed memory module, or a combination of removable and fixed memory modules.

The data storage device 142 may be configured to store one or more rules for controlling a plurality of warnings and escalations of warning levels. As an example, a level 1 warning may include illuminating an indicator such as a graphical telltale. As another example, a level 2 warning may include illuminating an indicator and illuminating a warning light such as a light emitting diode. Such a warning light may be illuminated in a solid color in conjunction with the illuminated indicator. As a further example, a level 3 warning may include illuminating an indicator, illuminating a warning light such as a light emitting diode, and generating an audio alarm. Such a warning light may be illuminated in a solid illumination pattern or pulsed and may have a different illumination color from the color used in the level 2 warning. It should be noted that a fewer number or greater number of levels of warnings are contemplated. Moreover, different combinations of associated warning types are contemplated as well.

The data storage device 142 may be configured to store message data for at least one pop-up message. In aspects, the data storage device 142 stores message data for a plurality of pop-up messages. The data storage device 142 may be configured to store operation manuals, performance and duty cycle history data, operator-specific information, workplace-specific information, machine-specific information, and any other type of information associated with the machine 100 and/or a geographical area information associated with the location of the machine 100.

In an aspect, the data storage device 142 may include one or more data stores or databases storing message data for a plurality of pop-up messages in tabular form, as shown in Table I. Each row of Table I may include message data associated with a particular machine condition. The first column includes a unique numeral—an Event ID (EID)—associated with the particular machine condition. The second column includes a numerical rank, e.g., a Warning Level, in a priority hierarchy assigned to the particular machine condition. The priority hierarchy may be organized according to the severity of, and/or the risk posed by, the particular machine condition. In the illustrated aspect, warning events may be assigned to one of three ranks where Warning Level 3 is the most critical warning level. The third column includes a text string including a description of the particular machine condition. The fourth column includes a text string including an identification of the particular System exhibiting the particular machine condition. The fifth column includes a text string including an identification of the nature of the Condition. The sixth column includes a text string including a corrective action (Action) for the operator to follow in response to the particular machine condition.

TABLE I

| | WARNING | | | | |
|---|---|---|---|---|---|
| EID | LEVEL | DESCRIPTION | SYSTEM | CONDITION | ACTION |
| 47 | 1 | Transmission Abuse | Trans Shift | ABUSE | Change |
| | | Warning | | | Operation |
| 47 | 2 | Transmission Abuse | Trans Shift | ABUSE | Change |
| | | Warning | | | Operation |
| 49 | 2 | Coasting in Neutral | Trans Shift | ABUSE | Change |
| | | Warning | | | Operation |
| 106 | 2 | High Front Brake | Brake Temp | HIGH | Change |
| | | Temp. | | | Operation |
| 107 | 2 | High Rear Brake | Brake Temp | HIGH | Change |
| | | Temp. | | | Operation |
| 155 | 2 | High Torque Converter | Torque Conv | HIGH | Change |
| | | Oil Temp. | Oil Temp | | Operation |
| 179 | 2 | Alternator Not | Charging | FAILURE | Service |
| | | Charging | System | | |
| 281 | 2 | Steering Hydraulic Oil | Steer Oil | RESTRICTION | Service |
| | | Filter Plugged | Filter | | |
| 327 | 3 | Low Output Transfer | OTG Press | LOW | Shutdown |
| | | Gear (OTG) Pressure | | | Safely |
| 328 | 3 | Output Transfer Gear | OTG Filter | RESTRICTION | Shutdown |
| | | (OTG) Filter Plugged | | | Safely |
| 329 | 3 | Transmission Filter | Trans Filter | RESTRICTION | Shutdown |
| | | Plugged | | | Safely |
| 330 | 3 | Transmission Output | Trans Speed | FAILURE | Shutdown |
| | | Speed Mismatched | Sens | | Safely |
| 542 | 2 | Low Steering Pump | Steer Oil | LOW | Service |
| | | Pressure | Press | | |
| 542 | 3 | Low Steering Pump | Steer Oil | LOW | Shutdown |
| | | Pressure | Press | | Safely |
| 556 | 2 | Low Brake Pump | Brake Oil | LOW | Service |
| | | Pressure | Press | | |

The event data in Table I are representative of machine parameters suitable for monitoring and for diagnostic analysis using the principles of the disclosure. In other aspects, other parameters well known in the art may be readily used with the principles of the disclosure.

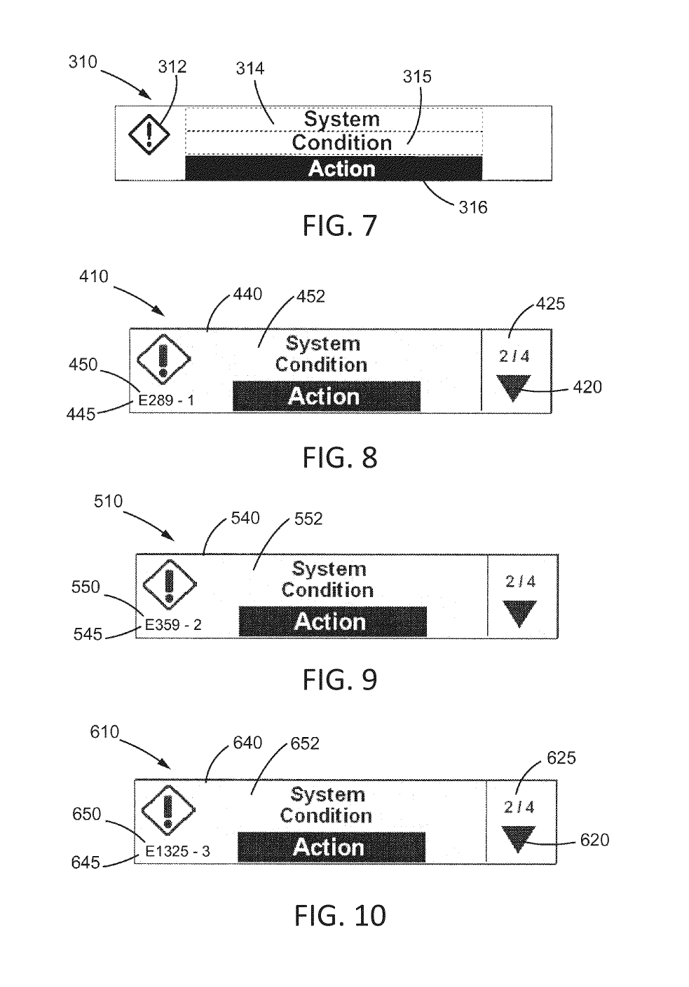

The operator interface 135 may be configured to provide the operator 140 with an operable interface to systems of the machine 100. The operator interface 135 may be coupled to the controller 145 to receive display data. The operator interface 135 may be disposed within the operator compartment 106 of the machine 100. The operator interface 135 may include a display screen 170 having a machine performance information display section 175 configured to display information indicating at least one machine parameter and a message display section 180 configured to selectively display a plurality of pop-up messages such as those illustrated in FIGS. 7-10. The message display section 180 may be disposed in offset relationship to the machine performance information display section 175. In aspects, the message display section 180 may include a dedicated information banner.

In certain aspects, the machine performance information display section 175 can be configured to display information relating to various categories such as alert messaging, machine health monitoring, real-time performance monitoring, video images or production reports, direction information, and navigation information for example. The arrangement of the categorical information may be predetermined and may be machine specific. The arrangement of the categorical information may be dynamic such as via an LCD display such that the operator interface 135 may be used in landscape or portrait orientation.

In certain aspects, the machine performance information display section 175 may include a plurality of graphical indicators 181. The graphical indicators 181 may be discrete indicators associated with a particular indication such as operator alert, parking brake, hydraulic lock, charging system, emission systems filter, diesel exhaust fluid level (DEF), regeneration (REGEN) active, emissions system malfunction, service required, brake system malfunction/failure, transmission failure, second steering active, steering failure, right turn signal, left turn signal, high beams, operator not present, seatbelt, body up, brake retarder, implement coupler, ladder down, bail down, limp home, quick shift, auto downshift, transmission neutralizer, auto shift, LH blade float, RH blade float, eco mode, differential lock, traction control, blade float, bucket float, winch lock, winch free spool, single tilt, cruise control, lockup clutch engaged, auto ejector, throttle hold, traction control, ride control, and the like. Graphical indicators 181 may be machine specific. A subset of the graphical indicators may be used across machines as a standard or fixed configuration. One or more of the graphical indicators 181 may be arranged along a periphery of the display screen 170. The graphical indicators 181 may be machine specific and may be selectively illuminated based on one or more color-coding procedures such as ISO 6011, ISO 6405-1, and/or ISO 3864. As an example, a first color (e.g., green) may be used to indicate an inform state such as a machine condition or mode indication (e.g., eco mode, blade float engaged, auto shift activated, etc.). As another example, a second color (e.g., yellow) may indicate an alert condition such as abnormal machine operation or out of range operation. As a further example, a third color (e.g., red) may indicate a warning such as a potential failure or safety condition (e.g., parking brake engaged, seat belt not fastened, etc.). In another aspect, the graphical indicators 181 may have an illuminated background with the indicative color, while the graphical symbol (e.g., indicia) of the indicator is not illuminated or illuminated in a color that is different from the indicative background color. As an example, the graphical indicators 181 that are informative only may have a non-illuminated background and an illuminated graphical symbol (indicia). As a further example, the graphical indicators 181 associated with alert conditions or warnings may have an illuminated background with a non-illuminated graphical symbol or a graphical symbol illuminated with a color that is different from the background color.

In certain aspects, the operator interface 135 may include one or more indicator lights 182. As an example, the one or more indicator lights 182 may be fixed position lights. As another example, the one or more indicator lights 182 may include one or more light emitting diodes (LED's). Each of the one or more indicator lights 182 may have a different color from another of the one or more indicator lights 182. As a further example, one or more indicator lights 182 may be illuminated with a color that matches an illuminate color displayed in the message display section 180. In certain aspects, the indicator lights 182 may be or comprise LED's and the display screen may be or comprise a liquid crystal display (LCD).

In aspects, the brightness and/or color of the background of the display screen 170 may be adjusted. For example, in some aspects, the display screen 170 may be toggled between a day mode and a night mode, for example. The day mode may have a different color scheme and/or brightness than the night mode.

The sensors 137 may be in electrical communication with the controller 145. Each sensor 137 may be configured to detect an operational parameter of the machine 100 and to provide a signal indicative of the detected operational parameter to the controller 145. In aspects, the controller 145 may be configured to provide operational parameter information to the operator interface 135 for display via the machine performance information display section 175 of the display screen 170. The controller 145 may be configured to process information received from the sensors 137 to cause the graphical indicators 181 and/or the indicator lights 182 to selectively illuminate.

The sensors 137 may include any suitable sensor capable of detecting at least one machine condition. Exemplary sensors 137 may include a variety of physical sensors monitoring safety and operational conditions of the machine 100, such as hydrogen detection sensors, temperature sensors, voltage and current sensors, speed sensors, flow sensors, position sensors, radar-based sensors, laser-based sensors, pressure sensors, RPM sensors, NOx sensors, CO₂ sensors, oxygen sensors, volume sensors, and any other type of sensor that may be useful to monitor at least one operation condition of the machine 100.

In aspects, one or more of the sensors 137 may be associated with an on-board module, which may include one or more control modules or interface modules within the machine 100 that control the particular sensor 137 and on-board components or other types of sub-components. The on-board module may be interposed between the particular sensor 137 and the processor 150. For example, an on-board module may include an Engine Control Module (ECM), a power system control module, a Global Positioning System (GPS) interface device, an attachment interface that connects one or more sub-components, and any other type of device that the machine 100 may use to facilitate and/or monitor operations of the machine 100 during run time or non-run time conditions (i.e., machine engine running or not running, respectively). In such aspects, the controller 145 may be configured to respond to signals received from the sensors 137 either directly or indirectly through an on-board module.

The camera 139 may be configured to selectively provide a video signal for display in the machine performance information display section 175 of the display screen 170. In aspects, the processor 150 may be configured to determine whether to overwrite information disposed in the machine performance information display section 175 of the display screen 170 with a video image from the camera 139. In aspects, the image data provided by the video camera may be directed to the processor 150, which may be configured to selectively display the image data in the machine performance information display section 175 of the display screen 170.

The camera 139 may be mounted at any suitable location on the machine 100. For example, in aspects, the video camera may be mounted such that it captures a video image of the area to the rear of the machine 100. In some aspects, the camera 139 may be rear-mounted and be configured to be activated in two ways. The processor 150 may be configured to automatically display the image data from the camera 139 in the machine performance information display section 175 of the display screen 170 when the machine 100 may be placed in reverse. The image data may continue to be so displayed until the machine 100 is taken out of reverse. The processor 150 may also be configured to display image data from the camera 139 in the machine performance information display section 175 of the display screen 170 in response to receiving a camera display signal from the operator interface 135. The processor 150 may be configured to toggle back to a prior display configuration and cease the display of image data from the camera 139 in response to a return signal from the operator interface 135.

In some aspects, the camera 139 may be adjustably mounted such that the viewing angle of the camera 139 may be varied over a range of travel. Thus, the camera 139 may be mounted in a way to capture a video image of a position in a blind spot of the operator 140, which in turn may be viewed by the operator 140 in the machine performance information display section 175 of the display screen 170.

In aspects, the mounting position of the camera 139 may be varied. In aspects, a plurality of video cameras may be mounted to the machine 100 and selectively used to display video images in the machine performance information display section 175 of the display screen 170.

In aspects, the controller 145 may be configured to collect machine performance information from the sensors 137 and process the collected machine performance information for selective display by the operator interface 135. Machine performance information may include, for example, information associated with fuel consumption, the temperature of machine components and fluids, the pressure of machine fluids, fluid levels, fluid consumptions, load weight, speed, propulsion torque vs. speed history vs. vehicle position, duty cycle information for power-consuming components, idle time, number of engine starts, load type, work machine type, terrain type, terrain grade, type of material manipulated by the machine 100, hours of operation, work site parameter data, and any other type of information related to the machine 100, a work site, and/or operations associated with the work site. For example, the processor 150 may execute a software program to collect and display through the operator interface 135 information reflecting the ground speed of the machine 100.

The processor 150 may be configured to monitor operational conditions and to display warning information on the operator interface 135 in response to detected machine conditions, including fault conditions. For example, the processor 150 may be configured to collect oil pressure information from one or more of the sensors 137. The processor 150 may be configured to display a warning pop-up message containing warning information to indicate to the operator 140 that the oil pressure may be outside of threshold values. The processor 150 may be configured to display a warning pop-up message containing warning information to indicate to the operator 140 that the fuel level is below a threshold value. Further, the processor 150 may be configured to automatically respond to machine conditions to help an operator maintain or place the machine 100 in a safer condition or prevent the machine 100 from operating out of a safe operating range.

In certain aspects, the processor 150 may be configured to display one or more recommended corrective actions corresponding to a detected machine condition triggering a warning event. The corrective actions may include recommendations for altering the operation of the machine 100. For instance, in addition to providing display data reflecting warning information for a particular operational condition, the processor 150 may be configured to generate a suggested course of action that the operator 140 of the machine 100 may perform to correct the abnormal condition and/or to place the machine 100 in a relatively safer operating state. Accordingly, methods and systems following principles of the disclosure may provide recommendations of corrective actions to address a range of machine conditions that are unsafe and/or harmful to the machine 100 or the operator 140.

In aspects, the controller 145 may be configured to assemble a first pop-up message from the data in the data storage device 142 in response to receiving a signal indicative of a first machine condition and to provide the first pop-up message to the operator interface 135 for display in the message display section 180 of the display screen 170. The first pop-up message may include data describing the first machine condition.

The controller 145 may be configured to remove the first pop-up message from the display screen 170 for a first period of time in response to receiving a first hide signal from the operator interface 135. The controller 145 may be configured to re-display the first pop-up message in the message display section 180 of the display screen 170 after the first period of time has elapsed if the first machine condition still exists. The controller 145 may be configured to display an alert reminder symbol in the message display section 180 of the display screen 170 after removing the first pop-up message from the display screen 170 for the first period of time in response to receiving the first hide signal from the operator interface 135.

In aspects, the controller 145 may be configured to assemble a second pop-up message from the data in the data storage device 142 in response to receiving a signal indicative of a second machine condition and to provide the second pop-up message to the operator interface 135 for display in the message display section 180 of the display screen 170. The second pop-up message includes data describing the second machine condition. In aspects, the controller 145 may be configured to determine whether the first pop-up message may be displayed in the message display section 180 of the display screen 170 and, if so, rank the first pop-up message and the second pop-up message in a priority hierarchy and sequentially display the first pop-up message and the second pop-up message in an order according to rank.

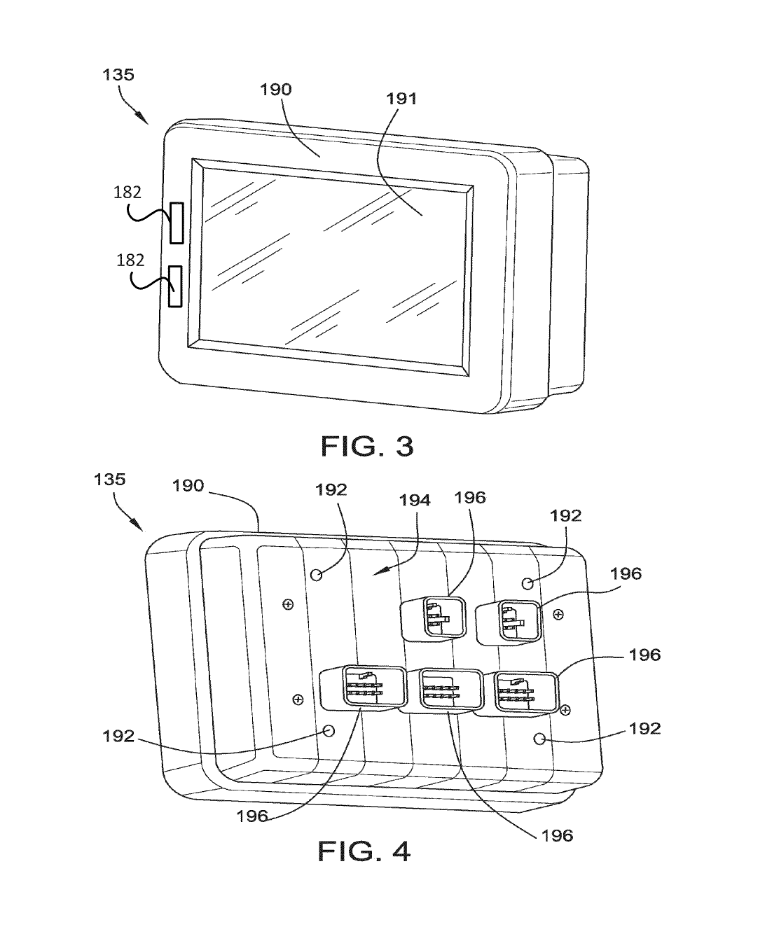

Referring to FIGS. 3 and 4, the illustrated aspect of the operator interface 135 may include a liquid crystal display device 190. In aspects, the operator interface 135 may include another type of display, a console, a keyboard, push buttons, voice recognition devices, a laptop computer, speakers, and/or other interfaces well known in the art. In aspects, the operator interface 135 may include any type of display device that presents information.

Referring to FIG. 3, the illustrated liquid crystal display device 190 may include a touch screen 191 as the display screen 170 configured to display information to the operator 140 of the machine 100 and to receive instructions from the operator 140 for transmission to the controller 145 via finger touch input. The touch screen 191 may be any suitable size, such as an eight-inch screen, for example, with any suitable aspect ratio, such as 1.66:1 or industry reference “Super 16,” for example. The illustrated touch screen 191 includes a color screen. In other aspects, different display screens 170 may be used. The operator interface 135 may be sized to fit various machines in various orientations. As an example, one or more of the indicator lights 182 may be disposed adjacent a portion of the touch screen 191. The one or more of the indicator lights 182 may be in a fixed position relative to the touch screen 191.

The touch screen 191 may be selectively activated using capacitive-touch technology as is well known to those skilled in the art. The touch screen 191 may be configured to detect anything which is conductive or has a dielectric different than that of air. In aspects, the touch screen 191 may be activated based on a human finger touch applying a predetermined amount of force to the touch screen 191. In aspects, the touch screen 191 may be configured to respond to immediate touch activation, push and hold activation, and activation upon lift off.

Referring to FIG. 4, the illustrated liquid crystal display device 190 may be capable of being mounted within a panel configuration in the operator compartment 106 or as a stand-alone device. Four mounting holes 192 are located on a back surface 194 of the liquid crystal display device 190 and are in spaced relationship to each other to facilitate the mounting of the display device 190. Suitable electrical connectors 196 may accessible through the back surface 194 to provide an electrical connection between the operator interface 135 and a power source, the controller 145, and other electrical components. The touch screen 191 may further include a housing as shown in FIG. 3 and FIG. 4 to protect the internal components thereof. The housing may be formed of a synthetic material. Moreover, the housing may be waterproof.

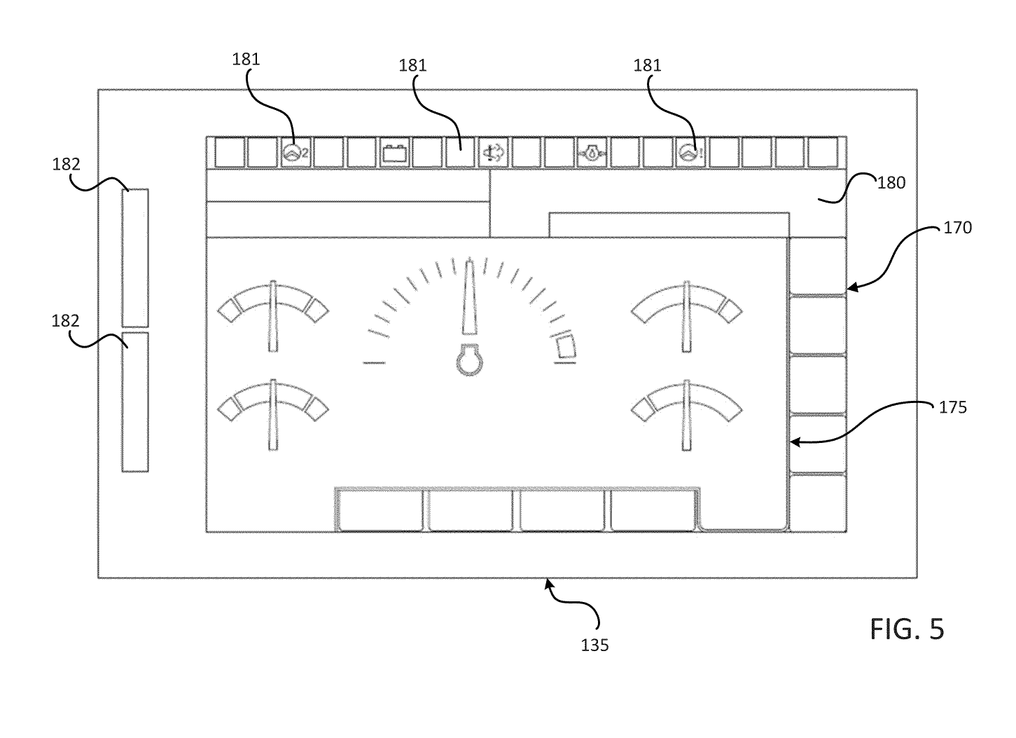

Referring to FIG. 5, in one aspect, the operator interface 135 may be configured for a landscape orientation, while in operation. The machine performance information display section 175 can be configured to display machine health and operational parameters (e.g., tachometer, speedometer, battery condition, oil pressure, water temperature, fuel level, diesel exhaust fluid (DEF) levels, etc.) and directional and/or navigational information such as heading, current location, destination information, and the like. The machine performance information display section 175 may include one or more user engageable buttons for adjusting menus and/or operational parameters of the associated machine 100.

As shown, the machine performance information display section 175 may include an arrangement of the graphical indicators 181. One or more of the graphical indicators 181 may be arranged along a periphery of the display screen 170 such as along a top periphery, for example. The message display section 180 may be disposed adjacent a portion of the graphical indicators 181. The one or more indicator lights 182 may be disposed in a fixed location adjacent a periphery of the machine performance information display section 175.

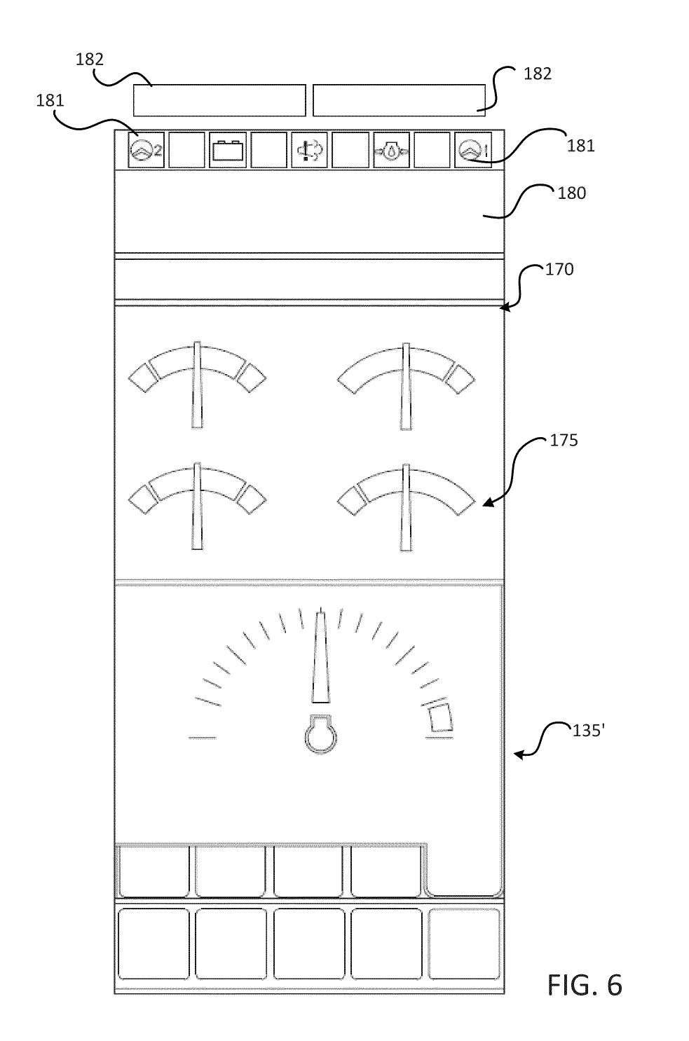

Referring to FIG. 6, in one aspect, an operator interface 135′ may be configured for a portrait orientation, while in operation. The machine performance information display section 175 can be configured to display machine health and operational parameters (e.g., tachometer, speedometer, battery condition, oil pressure, water temperature, fuel level, diesel exhaust fluid (DEF) levels, etc.) and directional and/or navigational information such as heading, current location, destination information, and the like. The machine performance information display section 175 may include one or more user engageable buttons for adjusting menus and/or operational parameters of the associated machine 100.

As shown, the machine performance information display section 175 may include an arrangement of the graphical indicators 181. One or more of the graphical indicators 181 may be arranged along a periphery of the display screen 170 such as along a top periphery, for example. The message display section 180 may be disposed adjacent a portion of the graphical indicators 181. The one or more indicator lights 182 may be disposed in a fixed location adjacent a periphery of the machine performance information display section 175.

Referring to FIG. 7, an aspect of a pop-up message configuration 310 is shown. The illustrated pop-up message configuration 310 includes a warning symbol 312 and a plurality of display field areas 314, 315, 316 for displaying data from the data storage device 142 regarding the detected machine condition. For example, the display field areas 314, 315, 316 may correspond to the following information categories: system, condition, and action. The system display field area 314 may contain information identifying which machine system is experiencing the condition. The condition display field area 315 may contain information identifying the particular condition detected. The action display field area 316 may contain information identifying a course of action for the operator to take in response to the detected machine condition.

Referring to FIG. 8, in aspects, the controller 145 may be configured to provide a pop-up message 410 with a scroll activation point 420 including a scroll arrow touch element when more than one pop-up message is active. Touching the scroll arrow touch element 420 sequentially displays active pop-up messages according to a priority hierarchy.

In aspects, the controller 145 may be configured to rank the active pop-up messages in the priority hierarchy. The controller may be configured to sequentially display the active pop-up messages in an order according to rank in response to receiving a scroll signal from the operator interface 135 by touching the scroll arrow touch element 420. In aspects, if the operator 140 has not sent a scroll signal by touching the scroll arrow touch element 420 for a predetermined amount of time (e.g., five seconds), the controller 145 may be configured to automatically page through the active pop-up messages, sequentially displaying each active pop-up message for a predetermined amount of time or until the operator 140 presses the scroll arrow touch element 420.

In aspects, if multiple information pop-up messages are active, the pop-up message 410 may include indicia 425 indicating the number of active pop-up messages as well as the number of that particular pop-up message. For example, the illustrated indicia 425 includes the text string “2/4,” which indicates this particular pop-up message 410 is the second pop-up message of four active pop-up messages.

Referring to FIGS. 8-10, aspects of pop-up messages 410, 510, 610 are respectively shown. Each of the pop-up messages 410, 510, 610 in FIGS. 8-10 may have the same pop-up message configuration 310 as shown in FIG. 10, but may also include indicia that informs the operator of the rank of the respective pop-up message 410, 510, 610 in the priority hierarchy.

In aspects, the controller may be configured to include indicia in each pop-up message signifying the rank of the particular pop-up message in the priority hierarchy. The controller may be configured to rank active pop-up messages in a priority hierarchy and sequentially display the active pop-up messages, each for a period of time, in an order according to rank. The controller may be configured to rank the active pop-up messages in the priority hierarchy and sequentially display the active pop-up messages in an order according to rank in response to receiving a scroll signal from the operator interface.

For example, the pop-up message 410 in FIG. 8 includes a Warning Level 1 pop-up message. The pop-up message area box 440 of the Warning Level 1 pop-up message 410 may contain rank indicia 445 that indicates its rank in the priority hierarchy. In aspects, the rank indicia 445 of the Warning Level 1 pop-up message 410 may include a text string 450 and a background color 452 of the pop-up message area box 440.

For example, in one aspect, the text string 450 includes a suffix, “−1,” which indicates the pop-up message 410 of FIG. 8 includes a Warning Level 1 pop-up message. In aspects, the indicia of different ranks in the priority hierarchy include a plurality of different colors which correspond to different ranks in the priority hierarchy. For example, in one aspect, the priority hierarchy includes a Warning Level 1 indicated by the color grey, a Warning Level 2 indicated by the color yellow, and a Warning Level 3 indicated by the color red. The illustrated background color 452 of the pop-up message area box 440 is grey to also signify the pop-up message 410 of FIG. 8 includes a Warning Level 1 pop-up message.

In aspects, the Level 1 Warning pop-up message 410 may be “snoozed” for a predetermined amount of time, after which it reappears if the machine condition generating the warning is still active. In aspects, the Level 1 Warning pop-up message 410 may be snoozed for a programmable amount of time in a range up to twelve hours.

Referring to FIG. 9, an aspect of a Level 2 Warning pop-up message 510 is shown. In aspects, the Level 2 Warning pop-up message 510 is ranked in a priority hierarchy to supersede any active Level 1 Warning pop-up messages.

The pop-up message area box 540 of the Warning Level 2 pop-up message 510 may contain rank indicia 545 that indicates its rank in the priority hierarchy. In aspects, the rank indicia 545 of the Warning Level 2 pop-up message 510 may include a text string 550 and a background color 552 of the pop-up message area box 540.

For example, in one aspect, the text string 550 includes a suffix, “−2,” which indicates the pop-up message 510 of FIG. 9 includes a Warning Level 2 pop-up message. The illustrated background color 552 of the pop-up message area box 540 is yellow to also signify the pop-up message 510 of FIG. 9 includes a Warning Level 2 pop-up message.

In aspects, the Level 2 Warning pop-up message 510 may be “snoozed” for a predetermined amount of time, after which it reappears if the machine condition generating the warning is still active. In aspects, the Level 2 Warning pop-up message 510 may be snoozed for a programmable amount of time in a range up to thirty minutes.

Referring to FIG. 10, an aspect of a Level 3 Warning pop-up message 610 is shown. In aspects, the Level 3 Warning pop-up message 610 is ranked as the highest priority in a priority hierarchy to supersede any active Level 1 and Level 2 Warning pop-up messages.

The pop-up message area box 640 of the Warning Level 3 pop-up message 610 may contain rank indicia 645 that indicates its rank in the priority hierarchy. In aspects, the rank indicia 645 of the Warning Level 3 pop-up message 610 may include a text string 650 and a background color 652 of the pop-up message area box 640.

For example, in one aspect, the text string 650 includes a suffix, “−3,” which indicates the pop-up message 610 of FIG. 10 includes a Warning Level 3 pop-up message. The illustrated background color 652 of the pop-up message area box 640 is red to also signify the pop-up message 610 of FIG. 10 includes a Warning Level 3 pop-up message.

If multiple pop-up messages are active, a scroll arrow touch element 620 and indicia 625 shall appear indicating so. In aspects, pressing the scroll arrow touch element 620 allows the operator 140 to page through all active pop-up messages, including active pop-up messages having a lesser rank. In aspects, if the operator 140 has not pressed the scroll arrow touch element 620 for a predetermined amount of time (e.g., 5 seconds), the controller 145 may be configured to sequentially display active Warning Level 3 pop-up messages only.

In aspects, the Level 3 Warning pop-up message 610 may be “snoozed” for a predetermined amount of time (e.g., 5 minutes), after which it reappears if the machine condition generating the warning is still active. In aspects, at least one Level 3 Warning pop-up message is configured such that it does not have an enabled snooze feature.

In aspects, a priority hierarchy may include warning pop-up messages as described above and information pop-up messages, which may be used to provide non-safety critical messages to the operator. In aspects, the information pop-up message may have a high level of configurability, thereby allowing each information pop-up message to be individually-customized to provide the appropriate information. The information pop-up message may include a text string including complete words to allow for greater understanding and better translation into different languages. In aspects, an information pop-up message is superseded by an active Level 1 Warning pop-up message.

### INDUSTRIAL APPLICABILITY

The Aspects of an indication display system for a machine are described herein. The industrial applicability of aspects constructed according to principles of the disclosure of an indication display system for a machine will be readily appreciated from the foregoing discussion. The described principles are applicable for use in multiple aspects of a machine, including trucks, cranes, earth moving vehicles, mining vehicles, cold planers, wheel loaders, backhoes, motor graders, track type tractors, hydraulic excavators, track type loaders, material handling equipment, farming equipment, marine vessels, aircraft, off-road vehicles, and other types of movable machines. Moreover, the principles disclosed herein may be incorporated in with other machines that are not movable including generator sets, turbines, mining equipment, and the like.

The disclosed systems and methods may provide a multi-functional user interface on a work machine to display information associated with the operations of the work machine. This information may include suggested corrective actions associated with detected abnormal operational conditions and/or service-triggering conditions of the machine.

In aspects, an indication display system for a machine includes a display screen having a dedicated information banner. The display screen is configured to maintain display of machine parameters and productivity information and simultaneously display the information banner. The information banner displays sacrificial information of lower priority when warning messages are not needed (such as operator name, temperature, time, etc.) and display critical message and/or warnings when needed.

When a machine condition is detected that triggers a pop-up message, the pop-up message is displayed in the information banner, and the sacrificial information is overwritten. An operator may touch the banner or button to snooze the pop-up message. The information banner again displays the sacrificial information and also displays an alert reminder symbol to indicate an active pop-up message has been removed from the display screen. The operator may touch the reminder symbol to launch a display that shows a list of warnings that have accumulated. The operator may select one of the warnings to launch another display having the details of the selected warning.

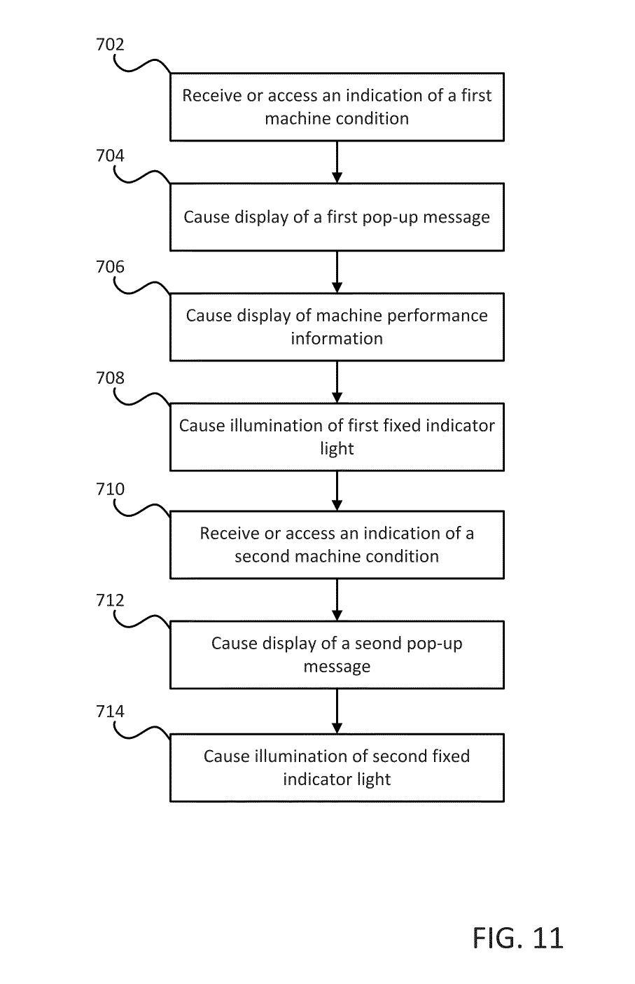

Referring to FIG. 11, steps of an aspect of a method of displaying operational information of a machine following principles of the disclosure are shown in flowchart form. In step 702, information relating to an indication of one or more first machine conditions may be received or accessed, for example, via one or more sensors (e.g., sensors 137 (FIG. 2)).

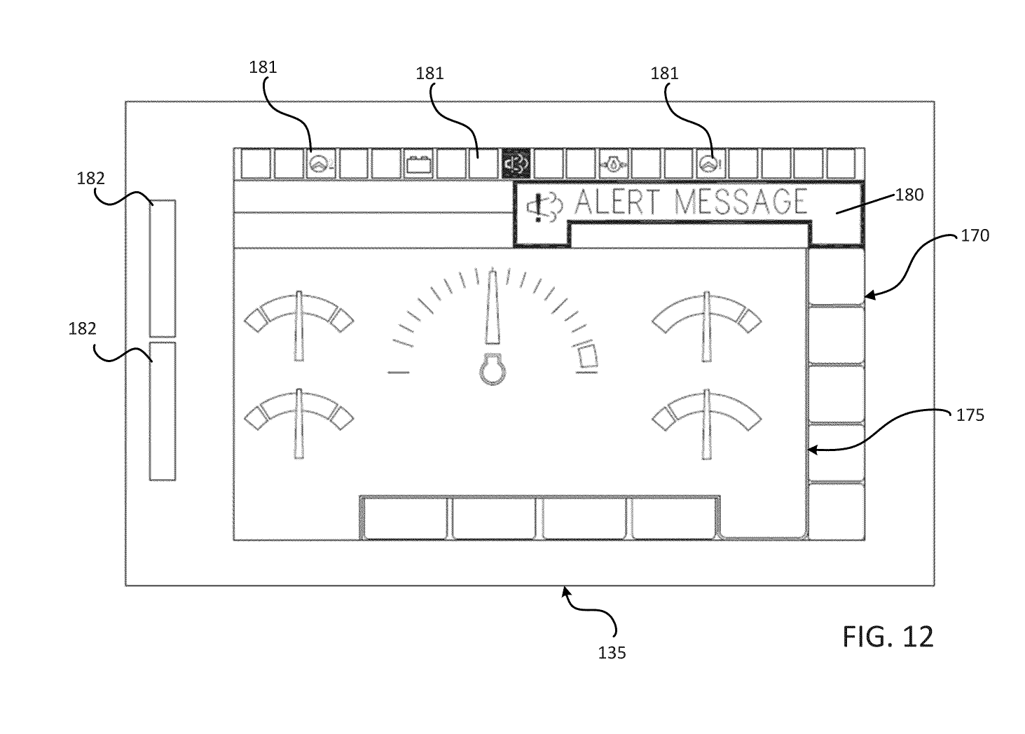

In step 704, in response to receiving an indication of a first machine condition, a first pop-up message may be caused to be displayed. As an example, the first pop-up message may be caused to be displayed in an information banner of a display screen of an operator interface. As another example, the first pop-up message may include data describing the first machine condition. As an illustrative example, the operator interface 135 is shown in FIG. 12 with at least one of the graphical indicators 181 illuminated simultaneously with the first pop-up message presented via the message display section 180. Such a configuration may be associated with a level 1 warning level. In certain aspects, the first pop-up message includes an illuminated color that matches an illuminated color of the illuminated graphical indicator 181. As an example, an operator may acknowledge the first pop-up message by engaging (e.g., contacting) a portion of the operator interface 135 such as the message display section 180.

In step 706, machine performance information may be caused to be displayed. As an example, the machine performance information may be caused to be displayed in a machine performance information display section (e.g., machine performance information display section 175 (FIG. 5)) of the display screen. As another example, the machine performance information may be caused to be displayed simultaneously with displaying the first pop-up message. As a further example, the information banner may be disposed in non-overlapping relationship with the machine performance information display section of the display screen.

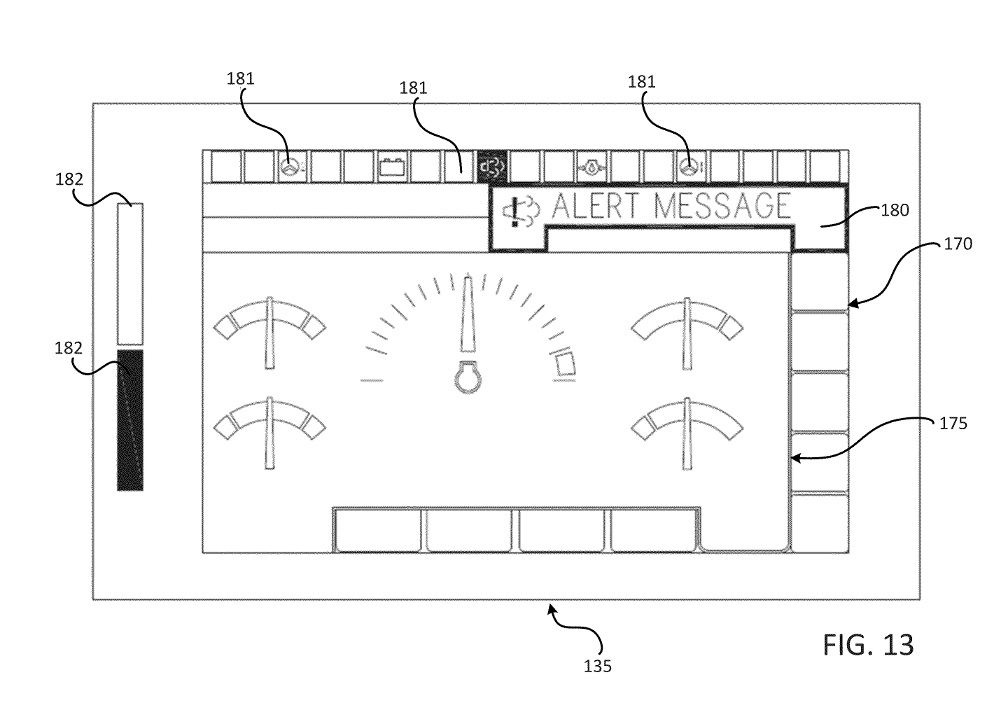

In step 708, a first fixed indicator light may be caused to be illuminated. As an example, the first fixed indicator light may be disposed adjacent the machine performance information display section. As a further example, the first fixed indicator light may be caused to be illuminated simultaneously with displaying the first pop-up message. As an illustrative example, the operator interface 135 is shown in FIG. 13 with at least one of the graphical indicators 181 and a first one of the indicator lights 182 illuminated simultaneously with the first pop-up message presented via the message display section 180. Such a configuration may be associated with a level 2 warning level. In certain aspects, the first pop-up message includes an illuminated color that matches an illuminated color of the first one of the indicator lights 182 and/or the graphical indicator 181. As an example, an operator may acknowledge the first pop-up message by engaging (e.g., contacting) a portion of the operator interface 135 such as the message display section 180.

Returning to FIG. 11, in step 710, information relating to an indication of one or more second machine conditions may be received or accessed, for example, via one or more sensors (e.g., sensors 137 (FIG. 2)).

In step 712, in response to receiving an indication of a second machine condition, a second pop-up message may be caused to be displayed. As an example, the second pop-up message may be caused to be displayed in the information banner (e.g., message display section 180 (FIG. 5)) of the display screen of the operator interface. As another example, the second pop-up message may include data describing the second machine condition.

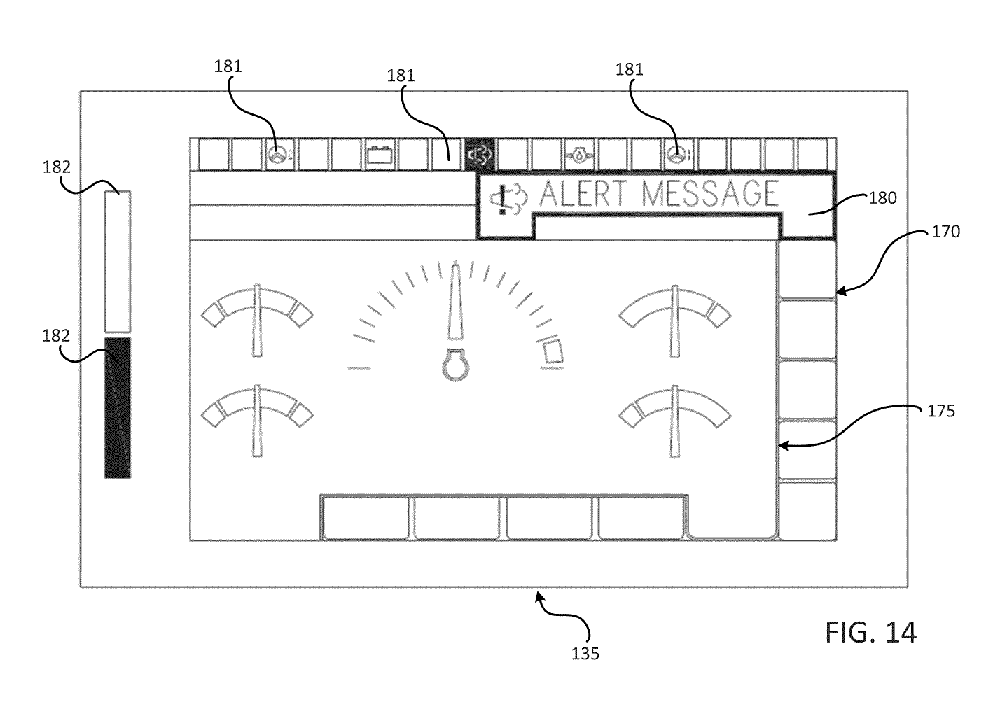

In step 714, a second fixed indicator light may be caused to be illuminated. As an example, the second fixed indicator light may be disposed adjacent the machine performance information display section. As a further example, the second fixed indicator light may be caused to be illuminated simultaneously with displaying the second pop-up message. As an illustrative example, the operator interface 135 is shown in FIG. 14 with at least one of the graphical indicators 181 and a second one of the indicator lights 182 illuminated simultaneously with the second pop-up message presented via the message display section 180. Such a configuration may be associated with a level 3 warning level. In certain aspects, the second pop-up message includes an illuminated color that matches an illuminated color of the second one of the indicator lights 182 and/or the graphical indicator 181. As an example, an operator may acknowledge the second pop-up message by engaging (e.g., contacting) a portion of the operator interface 135 such as the message display section 180. An audible alarm may also be generated simultaneously with the illumination of the second one of the indicator lights 182.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. An indication display system for a machine, comprising:
an operator interface including a display screen, the display screen having at least one fixed indicator light and a machine performance information display section configured to display information indicating at least one machine parameter and a message display section configured to selectively display at least one pop-up message, wherein the fixed indicator light is disposed adjacent a portion of the machine performance information display section;
a data storage device, the data storage device storing at least message data; and
a controller operably connected to the data storage device and the operator interface, the controller, in response to receiving a signal indicative of a first machine condition, configured to illuminate the fixed indicator light and to assemble from the message data in the data storage device a first pop-up message describing the first machine condition and to provide the first pop-up message to the operator interface for display in the message display section of the display screen simultaneously with illumination of the fixed indicator light.

2. The indication display system of claim 1, wherein the display screen comprises a touch screen configured to facilitate operator engagement of at least a portion of the message display section.

3. The indication display system of claim 1, wherein the machine performance information display section comprises a plurality of graphical indicators.

4. The indication display system of claim 3, wherein each of the plurality of graphical indicators is a discrete indicator associated with a particular machine condition.

5. The indication display system of claim 3, wherein one or more of the plurality of graphical indicators is configured to illuminate a background of the graphical indicator.

6. The indication display system of claim 3, wherein the pop-up message is disposed adjacent one or more of the plurality of graphical indicators.

7. The indication display system of claim 1, wherein the first pop-up message includes an illuminated color that matches an illuminated color of the fixed indicator light.

8. The indication display system of claim 1, wherein the controller is configured to assemble from the message data in the data storage device a second pop-up message describing the second machine condition in response to receiving a signal indicative of a second machine condition and to provide the second pop-up message to the operator interface for display in the message display section of the display screen.

9. The indication display system of claim 8, further comprising a second fixed indicator light disposed adjacent the first fixed indicator light.

10. The indication display system of claim 9, wherein the controller is configured to illuminate the second fixed indicator light simultaneously with providing the second pop-up message to the to the operator interface for display.

11. The indication display system of claim 10, wherein the second pop-up message includes an illuminated color that matches an illuminated color of the second fixed indicator light.

12. A machine configured to be controlled by an operator, comprising:
a frame;
a plurality of ground-engaging devices mounted to the frame;
an engine operably coupled to at least one of the plurality of ground-engaging devices;
an operator compartment supported by the frame; and
an indication display system, the indication display system including:
an operator interface including a display screen, the display screen having at least one fixed indicator light and a machine performance information display section configured to display information indicating at least one machine parameter and a message display section configured to selectively display at least one pop-up message, wherein the fixed indicator light is disposed adjacent a portion of the machine performance information display section;
a data storage device, the data storage device storing at least message data; and
a controller operably connected to the data storage device and the operator interface, the controller, in response to receiving a signal indicative of a first machine condition, configured to illuminate the fixed indicator light and to assemble from the message data in the data storage device a first pop-up message describing the first machine condition and to provide the first pop-up message to the operator interface for display in the message display section of the display screen simultaneously with illumination of the fixed indicator light.

13. The machine of claim 12, further comprising: one or more sensors in electrical communication with the controller, each sensor configured to detect an operational parameter of the machine and to provide a signal indicative of a value of said operational parameter to the controller, wherein the controller is configured to provide operational parameter information to the operator interface for display in the machine performance information display section of the display screen.

14. The machine of claim 12, wherein the display screen comprises a touch screen configured to facilitate operator engagement of at least a portion of the message display section.

15. The machine of claim 12, wherein the machine performance information display section comprises a plurality of graphical indicators.

16. The machine of claim 12, wherein one or more of the plurality of graphical indicators is configured to illuminate a background of the graphical indicator.

17. The machine of claim 12, wherein the first pop-up message includes an illuminated color that matches an illuminated color of the fixed indicator light.

18. A method of displaying operational information of a machine, comprising:
displaying, in response to receiving an indication of a first machine condition, a first pop-up message in an information banner of a display screen of an operator interface, the first pop-up message including data describing the first machine condition;
displaying machine performance information in a machine performance information display section of the display screen simultaneously with displaying the first pop-up message, the information banner being disposed in non-overlapping relationship with the machine performance information display section of the display screen; and
illuminating a first fixed indicator light disposed adjacent the machine performance information display section simultaneously with displaying the first pop-up message.

19. The method of claim 18, further comprising: displaying, in response to receiving an indication of a second machine condition, a second pop-up message in the information banner of the display screen of the operator interface, the second pop-up message including data describing the second machine condition and illuminating a second fixed indicator light disposed adjacent the machine performance information display section simultaneously with displaying the second pop-up message.

20. The method of claim 19, wherein the first pop-up message includes an illuminated color that matches an illuminated color of the first fixed indicator light and wherein the second pop-up message includes an illuminated color that matches an illuminated color of the second fixed indicator light.
